(19) United States
(12) Patent Application Publication
(10) Pub. No.: US 2007/0110624 A1
(43) Pub. Date: May 17, 2007

(54) Automation for opening and closing tubes fitted with a swinging cap

(76) Inventors: Philippe Lare, Pers-Jussy (FR); Sebastien Calvo, Annemasse (FR); Michael Gazeau, Saint-Julien-En-Genevois (FR)

Correspondence Address: HARNESS, DICKEY & PIERCE, P.L.C., P.O. BOX 828, BLOOMFIELD HILLS, MI, 48303, US

(21) Appl. No.: 11/375,689

(22) Filed: Mar. 14, 2006

Related U.S. Application Data
(63) Continuation of application No. PCT/FR04/02339, filed on Sep. 15, 2004.

(30) Foreign Application Priority Data
Sep. 15, 2003 (FR) 03/10799

(51) Int. Cl. B01L 3/00

(52) U.S. Cl. 422/99

(57) ABSTRACT

Automation treats samples placed in tubes provided with a tiltable plug connected to the tube body by a hinge. The automation is provided with a bottle opener consisting of an arm or a plate provided with shoulder interlocking under the flange of the tube plug and means for actuating said arm in a substantially tangential direction with respect to the trajectory of the flange during the opening of said plug by tilting.

### CROSS REFERENCE TO RELATED APPLICATIONS

This application is a continuation of Serial No. PCT/FR2004/002339, filed Sep. 15, 2004, which claims priority to French Application No. 03/10799, filed Sep. 15, 2003, both of which are incorporated by reference herein.

### BACKGROUND AND SUMMARY

This invention relates to the field of automata for the treatment of samples, particularly but not exclusively, biological or chemical samples with the aim of performing an analysis protocol.

The samples and, when applicable, the reagents are contained in tubes fitted with a cap. These tubes are inserted in a support, for example, the rotor of a centrifuge, or a support of an agitator. They can be inserted directly in housings intended for receiving the tubes to be treated or in a cradle that affords them a degree of angular freedom.

The tubes are fitted with caps that prevent the contents from being ejected during agitation or centrifugation operations. Generally, the cap is screwed on or pushed into the end of the tube. In certain tubes, this cap is fixed onto the tube by means of a hinge that makes it possible to open or close the cap by swinging this hinge. These tubes are, for example, sold under the trade name Cap-Lok® Two-Step Locking Cap by the company Robbins. The use of tubes fitted with such caps is of interest for sample-treating automata since, contrary to the screw-on caps, they remain attached to the tube. This speeds up the opening and closing process and reduces the risks of the products being spilled in the automation and cross contamination between the samples. It is not possible, using current automata, to fully automate a treatment using tubes fitted with a swinging cap, according to a protocol that requires a reagent to be introduced between two centrifugation steps, for example, or the contents of the tube to be transferred after an agitation or centrifugation process.

The aim of this invention is to solve this problem by providing an improved automation, comprising means that make it possible to automate the closing and opening of known tubes or tubes that have been specifically adapted for such an automation. For this purpose, the invention relates, in the broadest sense possible, to an automation for the treatment of samples placed in tubes fitted with a swinging cap connected to the body of the tube by means of a hinge, characterised in that it includes means for removing the cap that comprise an arm with a shoulder that can engage under a lip of the cap of a tube, and means for activating said arm in a direction that is substantially tangential to the trajectory of said lip when swinging said cap open.

The automation according to the invention advantageously comprises a centrifugation rotor that has housings in which said tubes can be positioned. According to an alternative, the automation comprises cradles for supporting said tubes. The means for removing the cap advantageously comprise a plate or an arm that can swing around an axle that is substantially parallel to the hinge that joins the cap to the tube body, the end of said arm having means for engaging with the edge of the cap opposite said hinge.

According to an alternative, the means for removing the cap comprise a plate extended by at least one tab that extends perpendicularly in relation to said plate, the tab being able to deform elastically and having a prong that can engage with a projecting part of the cap of a tube. According to another alternative, the means for removing the cap according to the invention can be adapted to open sets of tubes positioned symmetrically. For this reason, it is provided with two arms or plates that can swing around axles that are substantially parallel to the hinge that joins the cap to the body of the tube.

### BRIEF DESCRIPTION OF DRAWINGS

The invention will be better understood after reading the following description, which refers to a non-exhaustive example of an embodiment of the invention, in which:

FIG. 1 shows a partial view of an example of an embodiment of means for removing the cap.

FIG. 2 shows a front view, representing the movement, of the means for removing the cap.

FIGS. 3 and 4 show two views of an alternative embodiment; and

FIGS. 5 to 7 show views of another alternative embodiment.

### DETAILED DESCRIPTION

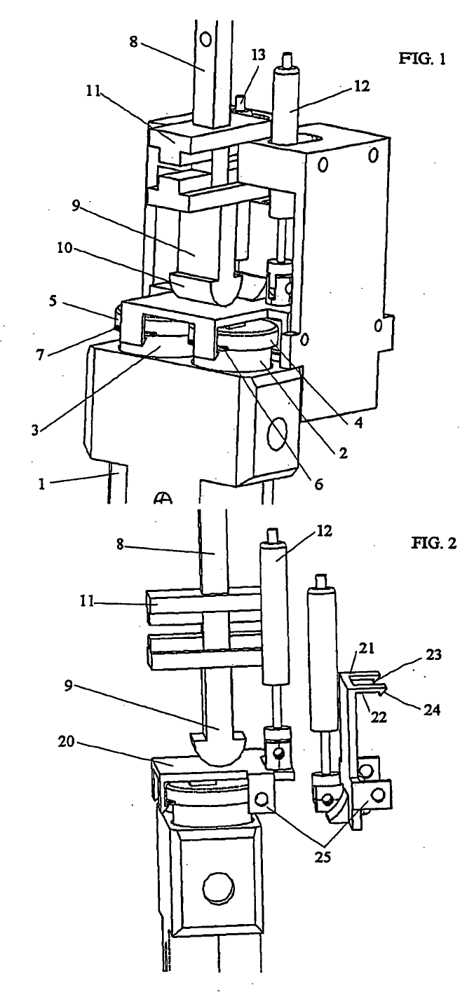

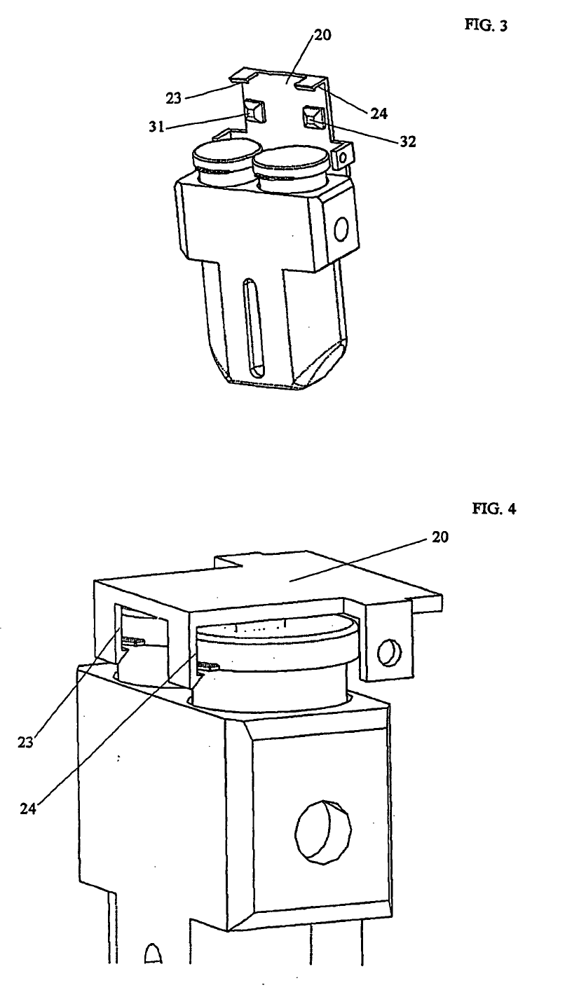

FIGS. 1 and 2 show a first alternative of an embodiment of the means for removing the cap. The automation comprises cradles 1 which house the tubes 2, 3 that are sealed using caps 4, 5 with a series of protusions 6, 7, on the side opposite the hinges, in the shape of an arc of a circle with a width of several dozen millimetres, extending through approximately 40°. An arm 8, which is horizontally and vertically mobile, activating a swinging plate with a flat or convex inner face 9, is adapted to come into contact with the surface of the caps in order to ensure they close. The arm 8 is driven transversally along a guiding rail 11.

The means for removing the cap comprise, among others, a plate 20 extended longitudinally by two tabs 21, 22 that can deform elastically. These tabs each have a prong 23, 24 that extends towards the inside. These prongs 23, 24 form a shoulder. A plunger cylinder 12 provides the vertical movement of the arm, between a position in which the shoulder 9 engages with the protusion 6, 7 of a cap, and a raised position in which the shoulder 9 makes the cap swing.

This plate 20 is mobile in rotation around a pivot 25 parallel to the hinge of the tube. It is activated by a movement of horizontal translation of the arm 8, which provides the swinging of the plate. Initially, the front (as opposed to the pivot 25) of the plate swings downwards in order to allow the projecting part 6, 7 of the cap to engage with the prongs 23, 24 formed on the tabs 21, 22. Then, the plate swings in the opposite direction to make the cap open. It is possible to add a second plate, symmetrical to the first, which is activated by the same arm 8 and which makes it possible to open the caps of tubes positioned in the automaton symmetrically in relation to the first set.

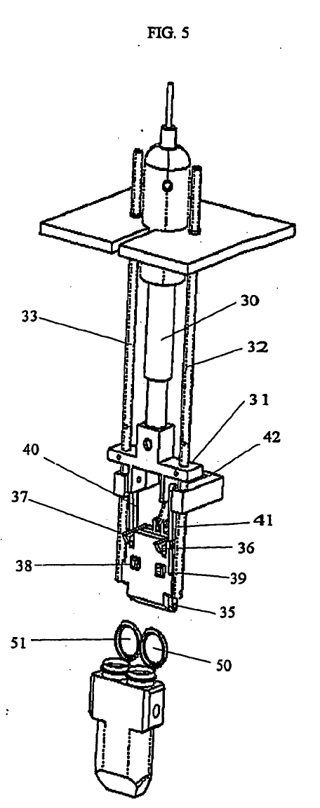

FIGS. 3 and 4 show an alternative embodiment of the invention. The plate has, on its inner surface, two foam buffers that are able to deform elastically 31, 32. These buffers rest against the surface of the cap during the cap-engagement phase. In the alternative described above, the operation of the automatic cap-removing device requires a movement around two axles. Another alternative enables operation with movement around a single vertical axis.

FIG. 5 shows a view of the device when not working. It includes a plunger cylinder 30 fixed on the automation. This plunger cylinder activates a mobile plate 31 guided laterally by two rods 32, 33 parallel to the longitudinal axis of the plunger cylinder 30. These rods 32, 33 have a series of grooves that assure the blocking of the mobile plate 31 in its upper and lower positions. For this purpose, the plate comprises pressure balls that become housed in the grooves when the plate is in either of its end positions. The swinging plate 35 has two articulated prongs 35, 36 used for hooking onto the edges of the lid and two cushions 38, 39 that rest on the cap when the plate is in its lower position, in order to assure easier opening and closing. The swinging plate 35 is linked to the mobile plate 30 by connecting rods 40, 41.

The operational mechanism of the tool comprising the swinging plate 35, the articulated hooks 36, 37 and the connecting rods 40, 41 is connected temporarily to the two axles 32, 33 by means of pressure balls on the plate 31 which cooperate with circular grooves machined on the axles 32, 33. A fixed plate 42 supports a cylinder with a pushing spring cylinder 43 assuring the opening and closing of the articulated prongs 35, 36.

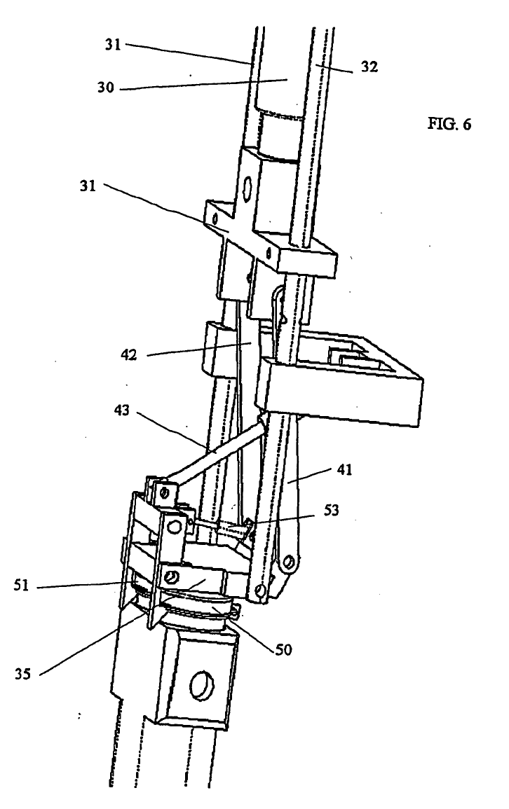

FIG. 6 shows the device in the position in which it is engaged with the caps 50, 51. When the cylinder reaches the end of its drawn-back position, the plate 31 is in the upper position and assures the rotation of the swinging plate 35 towards a position in which it rests against the caps 50, 51. The act of extending the plunger cylinder 43 makes the prongs 36, 37 grip the edges of the caps 50, 51.

To open the caps, the swinging plate 35 is in the horizontal position. The tool descends until the swinging plate 35 comes to rest against the upper face of the caps. For this purpose, the cylinder 30 pushes the mobile plate 31, which drives all the mechanism it supports, back down until the lower position determined by the grooves formed on the rods 32, 33. The hooks are in a raised position due to the action of a pulling cylinder 53 and only engage with the caps after an action of the pushing cylinder 43.

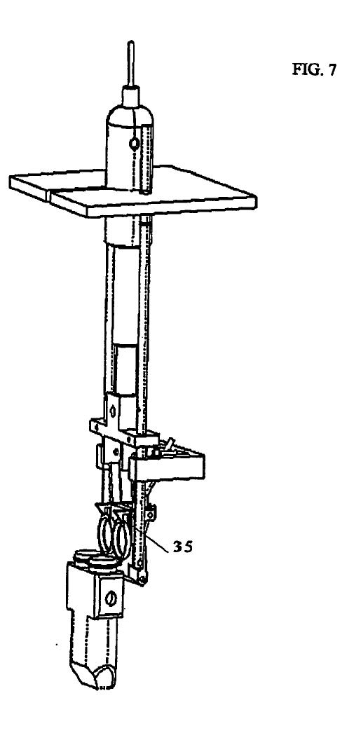

In a second stage, shown in FIG. 7, the swinging plate 35 is pushed back down, and it then swings into the vertical position. The hooks cause the caps to open. The tool can then be raised back up.

The invention claimed is:

1. Automation for the treatment of samples placed in tubes fitted with a swinging cap that is connected to the body of the tube by a hinge, the automation comprising a cap remover that comprises a member taken from the group of: an arm and a plate with a shoulder, that can engage under a lip of the cap of a tube, and an activator moving the arm in a direction that is substantially tangential to the trajectory of said lip when swinging the cap open.

2. Automation according to claim 1, further comprising a centrifugation rotor with housings for placing the tubes.

3. Automation according to claim 1, further comprising cradles for supporting the tubes.

4. Automation according to claim 1, wherein the cap remover comprises an arm that can swing around an axle that is substantially parallel to the hinge that joins the cap to the tube body, the end of the arm having a device engaging with the edge of the cap opposite the hinge.

5. Automation according to claim 1, wherein the cap remover comprises a plate extended by at least one tab which extends perpendicularly in relation to the plate, the tab being able to deform elastically and having a prong adapted to engage with a projecting part of the cap of a tube.

6. Automation according to claim 5, wherein the plate is swingingly mobile around an axle that is parallel to the hinge which joins the cap to the tube.

7. Automation according to claim 1, further comprising an arm being mobile perpendicularly to the axle of the tube, between a position in which it rests against the surface of the cap and a free position.

8. Automation according to claim 5, wherein the plate has, on its bottom surface, at least one foam buffer which can deform elastically.

9. Automation according to claim 1, further comprising two symmetrical swinging arms or plates activated by the single arm to open or close two sets of symmetrically positioned tubes.

10. Automation according to claim 1, further comprising an activator located along a single axis operably opening and closing the caps of the tubes.
